(19) United States
(12) Patent Application Publication
(10) Pub. No.: US 2005/0072004 A1
(43) Pub. Date: Apr. 7, 2005

(54) Opening assist mechanism for a folding knife

(76) Inventor: Fred J. Carter III, Wichita Falls, TX (US)

Correspondence Address: NEEDLE & ROSENBERG, P.C., SUITE 1000, 999 PEACHTREE STREET, ATLANTA, GA, 30309-3915, US

(21) Appl. No.: 10/678,768

(22) Filed: Oct. 3, 2003

(51) Int. Cl. B26B 1/02

(52) U.S. Cl. 30/158; 30/159

(57) ABSTRACT

A folding knife including an elongate handle and blade. A tang of the blade is pivotally connected to the handle proximate the front end of said handle such that the blade is rotatable about a rotational axis. A pin is positioned on and extends from the tang of the blade. The pin is spaced apart from the rotational axis. The folding knife also includes a bias element housed within the blade cavity. The bias element has a free end. In operation, a portion of the bias element is in continuous urging contact with the pin to assist in the movement of the blade into its opening position.

### BACKGROUND OF THE INVENTION

1. Field of the Invention

This invention relates to folding tools, such as folding knifes, and more particularly to a mechanism for assisting the opening of a folding knife to an open position.

2. Background Art

Many types of folding tools are known. One well-known folding tool is the folding knife. One major concern of the user of a folding knife is the requirement of safely opening the knife to an open operative position. In the folding knife industry, there typically is provided a housing or handle for supporting the knife blade in the open position and for receiving the knife blade in the closed position. It is also known to cause the extended knife blade to be locked when in the open extended position. The present invention overcomes the deficiencies of folding knifes and opening mechanisms in the art by providing positive opening assistance to the user.

The present invention allows for the opening of the folding knife with only a single hand of the user, to the advantage of the general public. Further, because, in the present invention, the knife blade of the folding knife typically is manually moved a certain distance, whereupon the mechanism of the folding knife serves to urge the blade into the open position without the application of further outside force by the user, the folding knife of the present invention may not be considered a switch blade, and hence, is legal in most jurisdictions of the United States.

### SUMMARY OF THE INVENTION

The present invention relates to folding tools such as, for example, a folding knife. In one example, the folding knife has a blade and an elongate handle. The blade has tang at one end and has a cutting edge that extends along at least a portion of at least one side of the blade. The handle has a front end and a spaced back end. The handle also defines a recessed blade cavity therein. A pivot shaft is provided for pivotally connecting the tang of the blade to the handle. In one example, the blade is pivotally connected to the handle proximate the front end of the handle so that the blade is rotatable about a rotational axis between an open position, in which the blade is extended, and a closed position, in which at least a portion of the cutting edge of the blade is disposed within the recessed cavity of the handle.

The folding knife further comprises a pin and a bias element. The pin is positioned on and extends outwardly from the tang of the blade. Further, the pin is spaced apart from the rotational axis such that the pin follows a predetermined path as the blade in rotated relative to the handle. The bias element has a free end and is housed within the blade cavity. A portion of the bias element is in continuous urging contact with the pin to assist in the movement of the blade to the opening position. In use, the bias element exerts an opening force on the pin to urge the blade into the open position when the user manually moves the blade from its closed position to beyond an equilibrium position.

### DETAILED DESCRIPTION OF THE DRAWINGS

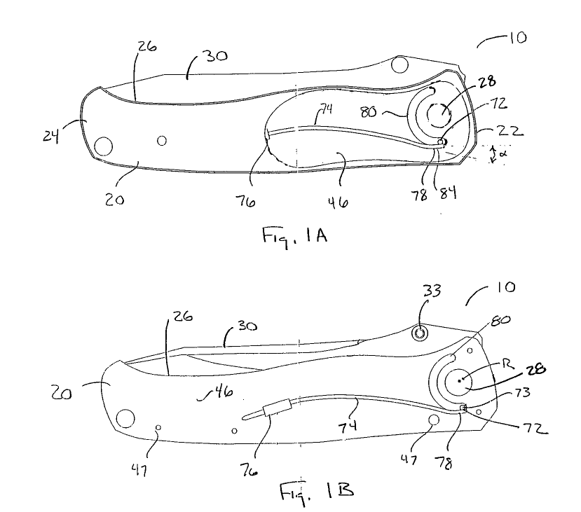

FIG. 1A is a partial cut-away side view of a folding knife in the closed position showing the construction and arrangement of a bias element housed within a bias element cavity when the folding knife is in its closed position.

FIG. 1B is a side view of the folding knife of FIG. 1A with a side member of a handle removed.

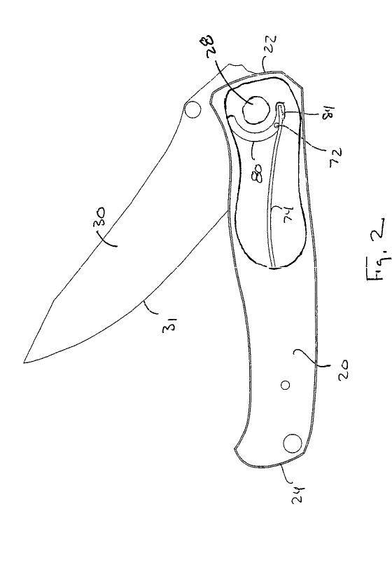

FIG. 2 is a partial cut-away side view of the folding knife of FIG. 1A with a knife blade being manually moved toward its open position.

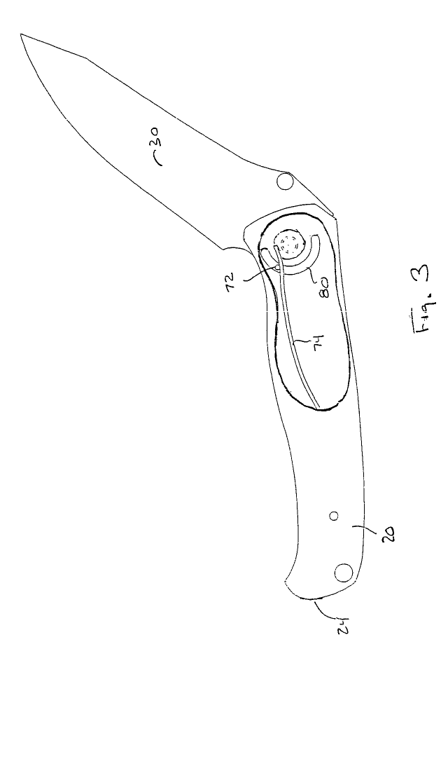

FIG. 3 is a partial cut-away side view of the folding knife of FIG. 1A with a knife blade being urged toward its open position by a blade opening assembly.

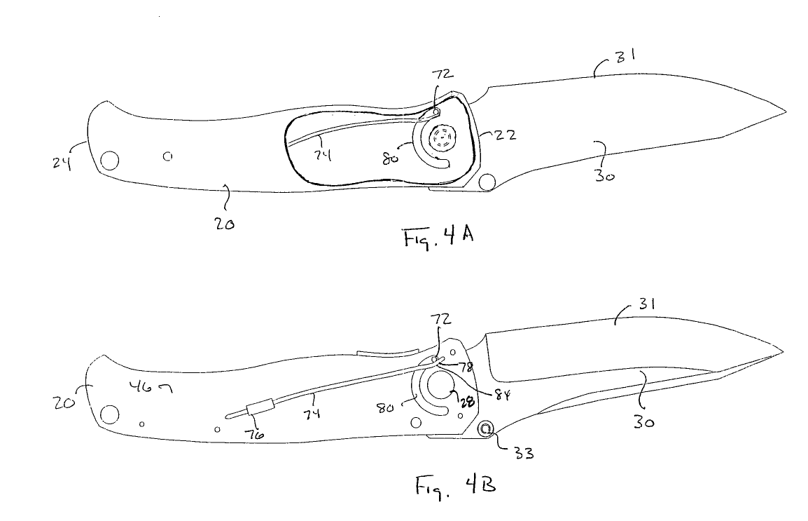

FIG. 4A is a partial cut-away side view of the folding knife of FIG. 1A with a knife blade in its open extended position.

FIG. 4B is a side view of the folding knife of FIG. 4A with a side member of a handle removed.

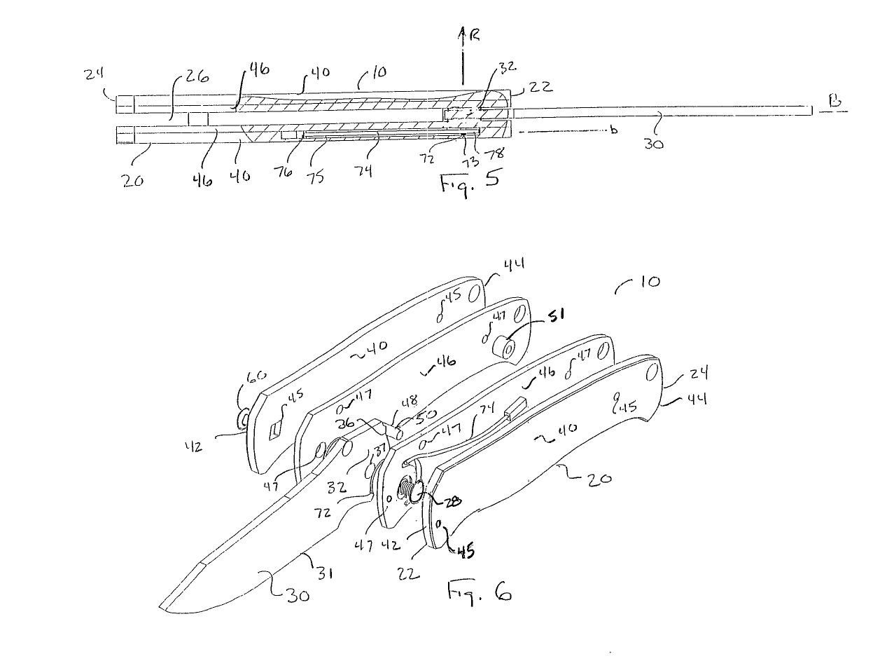

FIG. 5 is a partial cut-away top plan view of the folding knife in its open position.

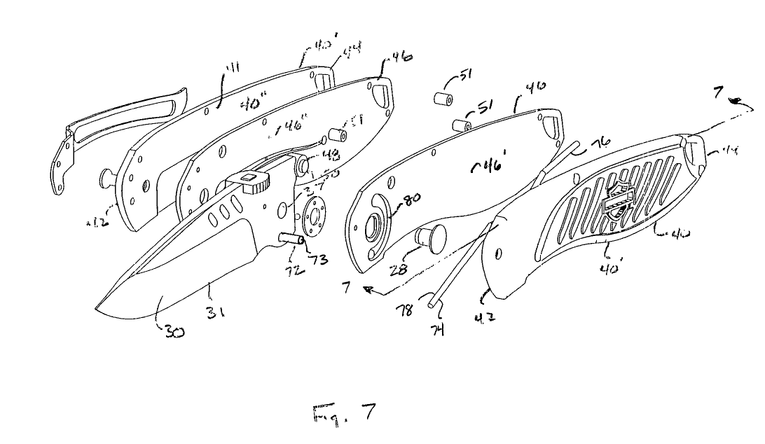

FIG. 6 is an exploded perspective view of the folding knife in its open position.

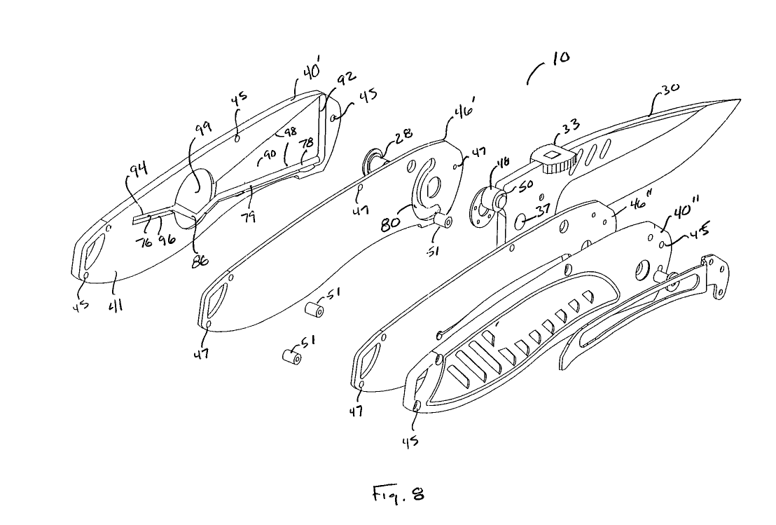

FIG. 7 is an exploded perspective view of an alternative embodiment of the folding knife in its open position.

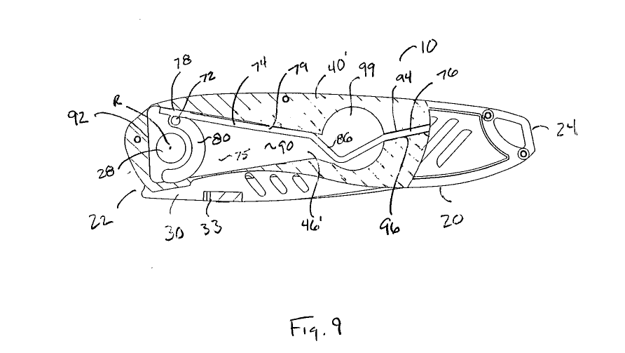

FIG. 8 is an exploded perspective view of the folding knife of FIG. 7 in its open position.

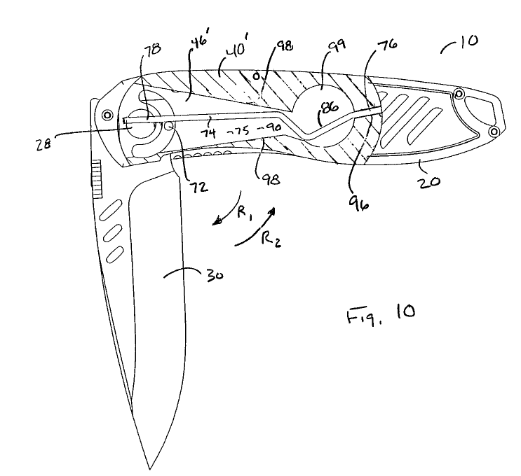

FIG. 9 is a partial cut-away side view of the folding knife of FIG. 7, taken partially along line 7-7 of FIG. 7, showing the construction and arrangement of a bias element housed within a recess in a side member of a handle when a knife blade is in its closed position.

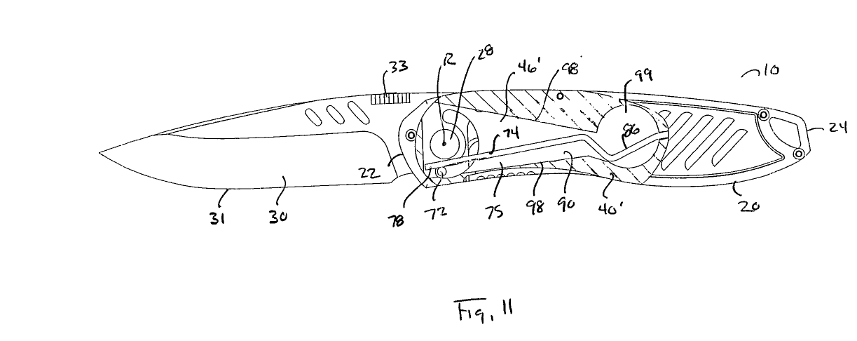

FIG. 10 is a partial cut-away side view of the folding knife of FIG. 9, taken partially along line 7-7 of FIG. 7, with the knife blade being urged toward its open position by a blade opening assembly.

FIG. 11 is a partial cut-away side view of the folding knife of FIG. 9, taken partially along line 7-7 of FIG. 7, with the knife blade in its open extended position.

### DETAILED DESCRIPTION OF THE INVENTION

The present invention is more particularly described in the following examples that are intended as illustrative only since numerous modifications and variations therein will be apparent to those skilled in the art. Thus the embodiments of this invention described and illustrated herein are not intended to be exhaustive or to limit the invention to the precise form disclosed. They are chosen to describe or to best explain the principles of the invention and its application and practical use to thereby enable others skilled in the art to best utilize the invention. As used in the specification and in the claims, “a,” “an,” and “the” can mean one or more, depending upon the context in which it is used. The preferred embodiment is now described with reference to the figures, in which like numbers indicate like parts throughout the figures.

The invention relates to folding tools having a handle and a working portion in which at least a portion of the working portion is foldable within a portion of the handle when the tool is not in use. Accordingly, the term “folding knife” as used herein should also be understood to include other types of folding implements such as files, hand saws, and the like. Furthermore, those skilled in the art will appreciate that the device described herein, and its principles of operation and implementation, is broadly applicable to a wide variety of foldable implements generally and may be adapted to tools rather than knifes. Thus, while the present invention is hereinafter described with particular reference to a folding knife, the skilled artisan will note its may other applications.

Referring to the figures, a folding knife 10 is shown that generally comprises an elongate handle 20 or casing, a blade 30, and a blade opening assembly for assisting the movement of the blade from a closed position to an open position. The handle has a front end 22, a spaced back end 24, and defines a recessed blade cavity 26 therein. As one will appreciate, at least a portion of the blade cavity is shaped so that at least a portion of the blade 30 may be disposed within the blade cavity when the blade is placed into a closed position.

In one embodiment, the handle has a pair of spaced opposing side members 40, each with a front end 42, a spaced back end 44, and an interior surface 41. The side members 40 define the recessed blade cavity 26 within the handle 20. The handle further comprises at least one liner member 46 housed within the blade cavity of the handle. A first liner member 46′ of the at least one liner member is connected to a first side member 40′ of the pair of side members and defines a bias element cavity 75 between portions of the connected first side member 40′ and the first liner member 46′. Each side member 40 may have a plurality of openings 45 that receive conventional fasteners 60, such as for example, threaded screws, bolts, nuts, and the like, to secure the side members 40 and/or liner members 46 to each other. Each liner member 46 may have a plurality of complementary holes 47.

The blade 30 has a cutting edge 31 along at least a portion of one side thereof and a tang 32 at one end. The blade may also have a thumb bob 33 mounted on a portion of the blade. The tang of the blade is rotatably mounted to the handle about a rotational axis R. In one example, the blade is mounted on a pivot shaft 28 extending between the first liner member 46′ and a second side member 40″ of the pair of side members 40 of the handle proximate the front end 22 of the handle. The tang defines a bore 37 constructed and arranged to receive the pivot shaft 28. In one example, the pivot shaft may be a conventional fastener. In operation, the blade is rotatable between the closed position, in which at least a portion of the cutting edge 31 is disposed within the blade cavity, and the open position, in which the blade is in an operative extended position.

In addition, one of the side members 40 or the liner members 46 may have at least one male projection 48 extending substantially normal to the interior side of the side member and/or liner member and the other side member and or liner member may have at least one female depression 49 constructed and arranged for receipt of the ends of the male projection. One of the male projections 48 proximate the front end of the handle may form a stop pin 50. The stop pin, by extending across a portion of the blade cavity, communicates with a stop 36 defined in the side edge of the tang when the blade is positioned in the open, extended, position. In another aspect, elongate spacers 51 may be positioned between the liner/side members. One will appreciate that each male projection 48 may be formed by a conventional fastener.

The folding knife of the present invention houses the blade opening assembly 70 within the blade cavity 26. In one example, the blade opening assembly comprises a pin 72 and a bias element 74. The pin is positioned on and extends from the tang of the blade. In one aspect, the pin 72 extends substantially transversely or normal to the side surface of the tang 32. The pin is spaced apart from the rotational axis of the blade 30 such that the pin 72 follows a predetermined path as the blade is rotated relative to the handle 20. At least a portion of the predetermined path is defined therein intermediate the back end 24 of the handle 20 and the rotational axis. The predetermined path of the pin 72 remains within the blade cavity as the blade is rotated through its range of movement. It is contemplated that the predetermined path of the pin is arcuate.

The bias element 74 is housed within the blade cavity 26. In one example, the bias element 74 is housed within the blade cavity such that the bias element 74 is positioned substantially to one side of a blade plane “B” defined by the blade 30. The bias element may be positioned substantially parallel to the blade plane. The bias element 74 may be constructed and arranged so that the bias element deflects in a bias element plane “b” that is substantially parallel to the blade plane.

The bias element has a fixed end 76 and a free end 78. For example, the bias element 74 may be a flexible or resilient rod. A portion of the bias element 74 proximate the fixed end is connected to the handle 20. A portion of the bias element proximate the free end thereof is in continuous urging contact with the pin 72 to assist in the movement of the blade to its open position. In one example, at least a portion of the bias element 74 is positioned at an angle with the longitudinal axis of the handle 20 such that the bias element is continually under tension throughout its range of contact with the pin 72. The bias element 74 exerts an opening force when the blade 20 is manually moved from its closed position to beyond a first equilibrium position in a first rotational direction. The bias element 74 also may exert a closing force when the blade is moved toward its closed position to beyond a second equilibrium position in a second rotational direction, opposite to the first rotational direction.

Referring to FIGS. 1-6, the bias element 74 may also have a bent portion 84 proximate the free end of the bias element. In this example, the bias element (including the “bent” free end portion of the bias element) may be substantially co-planar with respect to the bias element plane. In one embodiment, the bent portion 84 of the bias element is at an angle α with respect to an adjacent portion of the bias element is in the range of approximately less than 10 degrees. In a preferred embodiment, the angle α is in the range of approximately less than 20 degrees. In still another preferred embodiment, the angle α is in the range of approximately less than 30 degrees.

In one example, and as shown in the figures, a portion of the surface of the first liner member 46′ is spaced from a portion of the interior, facing surface 41 of the first side member 40′ to define the bias element cavity 75 therein the blade cavity 26 of the handle 20. In this example, the bias element is positioned intermediate the first liner member 46′ and the first side member 40′ and is housed therein the defined bias element cavity 75.

In one example, and as shown in the figures, the first liner member 46′ defines a slot 80 therein for operative receipt of the pin 72 of the blade opening assembly 70. The slot 80 is spaced with respect to the rotational axis of the blade and is constructed and arranged to accommodate the passage of the pin 72 as the pin travels along its predetermined path. In this example, the pin has a distal end 73 and at least a portion of the pin proximate the distal end extends above the interior surface of the first liner member 46′ and into the bias element cavity 75 where it operatively engages the portion of the free end 78 of the bias element 74 disposed within the bias element cavity 75. As one will appreciate, the slot 80 is shaped to accommodate the predetermined path of the pin. For example, if the predetermined path of the pin is arcuate, the slot will have a substantially arcuate shape.

The first side member 40′ may define an elongated recess 90 in a portion of the interior surface 41 of the side member. In this example, a portion of the first liner member 46′ and the recess 90 of the first side member define the bias element cavity 75. When the first liner member 46′ is positioned thereon the first side member 40′, a portion of the first liner member at least partially overlies the elongated recess 90 to form the bias element cavity, within which the bias element 74 is disposed. In this example, the bias element is housed within the elongated recess 90.

The recess 90 formed within the first side member 40′ has a first end 92 and a spaced second end 94. The first end of the recess is positioned intermediate the front end and back end of the first side member and the second end is positioned adjacent the front end of the first side member. In one example, the first end 92 of the recess defines an elongated groove 96 constructed and arranged for mounting a portion of the fixed end 76 of the bias element 74 therein. A portion of the recess also forms a pair of opposing side walls 98 intermediate the first and second ends of the recess. In one example, the pair of opposing side walls taper away from each other as the respective side walls approach the second end of the recess.

In another example, and referring to FIGS. 7-11, the bias element 74 may have a bent portion 86 intermediate the free end 78 and the fixed end 76. In one example, as the bias element extends from the fixed end to the free end, the bent portion initially extends downwardly toward the opening of the blade cavity and then upwardly away from the opening of the blade cavity. In this example, the recess 90 in the first side member 40′ has an intermediate portion 99 between the pair of opposing side walls 98 and the elongated groove 96 that is constructed and arranged for operative receipt of at least a portion of the bent portion 86 of the bias element throughout movement of the bias element as the blade is moved between the closed position and the open position. As one will appreciate from the figures, in this example, the bias element has an edge surface 79 extending from the fixed end to the free end of the bias element. At least a portion of the edge surface 79 of the bias element is in select contact with at least a portion of the side walls of the pair of opposing side walls and/or a portion of the intermediate portion of the recess 90 as the blade 30 is moved between the closed position and the open position.

In operation, the knife 10 in a closed position is grasped with the back end of the handle oriented toward the operator's wrist and the bottom of the handle 20 resting in the palm of the hand. In this position, the thumb bob 33 is in close proximity to the operator's thumb. Pressure applied to the thumb bob upwards in the direction away from the palm, causes the blade to rotate in the first rotational direction about the rotational axis and to exit the blade cavity. As the blade 30 is lifted out of the blade cavity, the blade opening assembly is moved past the first equilibrium point, after which the bias element 74 exerts the opening force onto the pin 73, which is connected to the tang of the blade. The tension in the bias element acting on the pin forces the pin to travel through its predetermined path until the blade is positioned in its open, operative, position. The stop bar 50 communicates with the blade 30 of the knife 10 to prevent overextension of the blade.

To close the knife 10, pressure is applied to the knife blade 30 to rotate the blade in the second rotational direction about the rotational axis towards the blade cavity. When the blade is near the closed position and the pin is near the limit of its travel along its path, the blade passes the second equilibrium position whereupon the bias element exerts the closing force onto the pin. When the blade is in the closed position, the tension in the bias element acting on the pin helps to retain the blade in the closed position. As one will appreciate, the closing force applied by the bias element is readily overcome by the operator as the knife is being initially moved in the first rotational direction when the knife is being opened.

It will be apparent to those skilled in the art that various modifications and variations can be made in the present invention without departing from the scope or spirit of the invention. Other embodiments of the invention will be apparent to those skilled in the art from consideration of the specification and practice of the invention disclosed herein. Although the present invention has been described with reference to specific details of certain embodiments thereof, it is not intended that such details should be regarded as limitations upon the scope of the invention except as and to the extent that they are included in the accompanying claims.

1. A folding knife, comprising:
a handle having a pivot shaft, the pivot shaft defining a rotational axis;
a blade having a tang at one end, the tang being rotatably mounted to the handle and about the pivot shaft between a closed position and an open position,
a pin positioned on and extending from the tang of the blade, the pin being spaced apart from the rotational axis;
a bias element having a fixed end and a spaced free end, said fixed end being connected to said handle, a portion of the bias element proximate the free end thereof being in continuous urging contact with the pin to assist in the movement of the blade into its open position.

2. The folding knife of claim 1, wherein the pin extends transversely from the tang of the blade.

3. The folding knife of claim 1, wherein the pin is spaced from the rotational axis such that the pin follows a predetermined path as the blade is rotated relative to the handle.

4. The folding knife of claim 3, wherein the predetermined path is arcuate.

5. The folding knife of claim 3, wherein the handle has a back end and wherein at least a portion of the predetermined path is defined therein intermediate the back end of the handle and the rotational axis.

6. The folding knife of claim 6, wherein the bias element is housed within said blade cavity such that the bias element is positioned substantially to one side of a blade plane defined by said blade.

7. The folding knife of claim 6, wherein the bias element is positioned substantially parallel to the blade plane.

8. The folding knife of claim 7, wherein the bias element is constructed and arranged so that the bias element deflects in a bias element plane, and wherein the bias element plane is parallel to the blade plane.

9. The folding knife of claim 3, wherein the handle includes a pair of spaced side members defining a blade cavity therebetween, each side member having an interior surface.

10. The folding knife of claim 9, wherein the handle further includes at least one liner member housed within the blade cavity, a first liner member of the at least one liner member being connected to a first side member of the pair of side members and defining a bias element cavity therebetween, the bias element being housed within the bias element cavity.

11. The folding knife of claim 10, wherein a slot is defined in the first liner member, the slot constructed and arranged for passage of the pin, the slot being spaced with respect to the rotational axis.

12. The folding knife of claim 11, wherein the pin has a distal end, and wherein at least a portion of the pin extends above the first liner member into the bias element cavity.

13. The folding knife of claim 12, wherein the slot has an arcuate shape.

14. The folding knife of claim 12, wherein each side member has a front end and a back end, wherein the first side member defines an elongated recess within the interior surface of the first side member, the recess having a first end, intermediate the front end and back end of the first side member, and a spaced second end, adjacent the front end of the first side member, the first end of the recess defining an elongated groove, wherein a portion of the recess forms a pair of opposing side walls intermediate the first and second ends of the recess, wherein the pair of opposing side walls taper away from each other as the respective side walls approach the second end of the recess.

15. The folding knife of claim 14, wherein a portion of the first liner member and the recess of the first side member define the bias element cavity.

16. The folding knife of claim 15, wherein a portion of the fixed end of the bias element is mounted therein the elongated groove of the recess.

17. The folding knife of claim 16, wherein the bias element has a bent portion intermediate the fixed end and the free end of the bias element.

18. The folding knife of claim 1, wherein the bias element is a flexible rod.

19. The folding knife of claim 1, wherein the bias element exerts an opening force when the blade is moved from its closed position to beyond a first equilibrium position in a first rotational direction.

20. The folding knife of claim 1, wherein the bias element exerts a closing force when the blade is moved toward its closed position to beyond a second equilibrium position in a second rotational direction.

21. A folding knife, comprising:
a. a blade having a cutting edge extending along at least a portion of at least one side thereof and a tang at one end;
b. an elongate handle having a front end, a back end, and defining a recessed blade cavity therein;
c. a pivot shaft constructed and arranged for pivotally connecting said tang to said handle proximate the front end of said handle so that the blade is rotatable about a rotational axis;
d. a pin positioned on and extending from the tang of the blade, the pin being spaced apart from the rotational axis;
e. a bias element housed within the blade cavity such that the bias element is positioned substantially to one side of a blade plane defined by said blade, the bias element having a free end, a portion of the bias element proximate the free end thereof being in continuous urging contact with the pin to assist in the movement of the blade into its opening position.

22. The folding knife of claim 21, wherein the pin extends transversely from the tang of the blade.

23. The folding knife of claim 22, wherein the pin is spaced from the rotational axis such that the pin follows a predetermined path as the blade is rotated relative to the handle.

24. The folding knife of claim 23, wherein the predetermined path is arcuate.

25. The folding knife of claim 23, wherein at least a portion of the predetermined path is defined therein intermediate the back end of the handle and the rotational axis.

26. The folding knife of claim 21, wherein the bias element is positioned substantially to one side of a blade plane defined by said blade.

27. The folding knife of claim 26, wherein the bias element is positioned substantially parallel to the blade plane.

28. The folding knife of claim 27, wherein the bias element is constructed and arranged so that the bias element deflects in a bias element plane, and wherein the bias element plane is parallel to the blade plane.

29. The folding knife of claim 23, wherein the handle comprises a pair of spaced side members defining the blade cavity therebetween, each side member having an interior surface.

30. The folding knife of claim 29, wherein the handle further includes at least one liner member housed within the blade cavity, a first liner member of the at least one liner member being connected to a first side member of the pair of side members and defining a bias element cavity therebetween, the bias element being housed within the bias element cavity.

31. The folding knife of claim 30, wherein the pivot shaft is connect to and extends between the first liner member and a second side member of the pair of side members.

32. The folding knife of claim 30, wherein a slot is defined in the first liner member, the slot constructed and arranged for passage of the pin, the slot being spaced with respect to the rotational axis.

33. The folding knife of claim 32, wherein the pin has a distal end, and wherein at least a portion of the pin extends above the first liner member into the bias element cavity.

34. The folding knife of claim 33, wherein the slot has an arcuate shape.

35. The folding knife of claim 33, wherein each side member has a front end and a back end, wherein the first side member defines an elongated recess within the interior surface of the first side member, the recess having a first end, intermediate the front end and back end of the first side member, and a spaced second end, adjacent the front end of the first side member, the first end of the recess defining an elongated groove, wherein a portion of the recess forms a pair of opposing side walls intermediate the first and second ends of the recess, wherein the pair of opposing side walls taper away from each other as the respective side walls approach the second end of the recess.

36. The folding knife of claim 35, wherein a portion of the first liner member and the recess of the first side member define the bias element cavity.

37. The folding knife of claim 36, wherein a portion of the fixed end of the bias element is mounted therein the elongated groove of the recess.

38. The folding knife of claim 37, wherein the bias element has a bent portion intermediate the fixed end and the free end of the bias element.

39. The folding knife of claim 21, wherein the bias element exerts an opening force when the blade is moved from its closed position to beyond a first equilibrium position in a first rotational direction.

40. The folding knife of claim 21, wherein the bias element exerts a closing force when the blade is moved toward its closed position to beyond a second equilibrium position in a second rotational direction.

41. A folding knife, comprising:
a. a blade having a cutting edge extending along at least a portion of at least one side thereof and a tang at one end;
b. an elongate handle having a front end, a back end, and defining a recessed blade cavity therein;
c. a pivot shaft constructed and arranged for pivotally connecting said tang to said handle proximate the front end of said handle so that the blade is rotatable about a rotational axis;
d. a pin positioned on and extending from the tang of the blade, the pin being spaced apart from the rotational axis;
e. a bias element housed within the blade cavity constructed and arranged such that the bias element deflects in a bias element plane that is parallel to one side of a blade plane defined by said blade, the bias element having a free end, a portion of the bias element proximate the free end thereof being in continuous urging contact with the pin to assist in the movement of the blade into its opening position.

42. The folding knife of claim 41, wherein the pin extends transversely from the tang of the blade.

43. The folding knife of claim 41, wherein the pin is spaced from the rotational axis such that the pin follows a predetermined arcuate path as the blade is rotated relative to the handle.

44. The folding knife of claim 43, wherein the handle comprises a pair of spaced side members defining the blade cavity therebetween, each side member having an interior surface, the handle further comprising at least one liner member housed within the blade cavity, a first liner member of the at least one liner member being connected to a first side member of the pair of side members and defining a bias element cavity therebetween, the bias element being housed within the bias element cavity.

45. The folding knife of claim 44, wherein the pivot shaft is connect to and extends between the first liner member and a second side member of the pair of side members.

46. The folding knife of claim 44, wherein a slot is defined in the first liner member, the slot constructed and arranged for passage of the pin, the slot being spaced with respect to the rotational axis.

47. The folding knife of claim 44, wherein the pin has a distal end, and wherein at least a portion of the pin extends above the first liner member into the bias element cavity.

48. The folding knife of claim 47, wherein each side member has a front end and a back end, wherein the first side member defines an elongated recess within the interior surface of the first side member, the recess having a first end, intermediate the front end and back end of the first side member, and a spaced second end, adjacent the front end of the first side member, the first end of the recess defining an elongated groove, wherein a portion of the recess forms a pair of opposing side walls intermediate the first and second ends of the recess, wherein the pair of opposing side walls taper away from each other as the respective side walls approach the second end of the recess and wherein a portion of the first liner member and the recess of the first side member define the bias element cavity.

49. The folding knife of claim 48, wherein a portion of the fixed end of the bias element is mounted therein the elongated groove of the recess.

50. The folding knife of claim 41, wherein the bias element exerts an opening force when the blade is moved from its closed position to beyond a first equilibrium position in a first rotational direction.

51. The folding knife of claim 41, wherein the bias element exerts a closing force when the blade is moved toward its closed position to beyond a second equilibrium position in a second rotational direction.
